(19) United States
(12) Patent Application Publication
(10) Pub. No.: US 2026/0138129 A1
(43) Pub. Date: May 21, 2026

(54) MICROFLUIDIC DEVICE

(71) Applicant: SHIMADZU CORPORATION, Kyoto-shi (JP)

(72) Inventors: Hirotaka SUZUKI, Kyoto-shi (JP); Masayuki OKADA, Kyoto-shi (JP)

(21) Appl. No.: 19/389,628

(22) Filed: Nov. 14, 2025

(30) Foreign Application Priority Data
Nov. 20, 2024 (JP) 2024-202059

(51) Int. Cl. B01L 3/00

(52) U.S. Cl. CPC B01L 3/502715; B01L 2200/14; B01L 2200/16; B01L 2300/021; B01L 2300/04

(57) ABSTRACT

A microfluidic device includes a plate-shaped member, a projection disposed on the plate-shaped member, and a first projecting portion disposed on the plate-shaped member. The plate-shaped member has a substrate having a first surface and a second surface, and a plurality of microfluidic channels formed on one of the surfaces. The projection and the first projecting portion are disposed on the first surface of the substrate. A distance from the first surface to a farthest end of the first projecting portion is greater than a distance from the first surface to a farthest end of the projection.

### DESCRIPTION

### TECHNICAL FIELD

The present disclosure relates to a plate-shaped microfluidic device that can be stored stacked. More specifically, the present disclosure relates to a technique for protecting a principal surface of the microfluidic device.

### BACKGROUND ART

Japanese Unexamined Patent Application Publication No. 2023-54876 (Patent Literature 1) discloses a microfluidic device including a plurality of microfluidic channels for testing the susceptibility of bacteria to antimicrobial agents and the like.

### Citation List

### Patent Literature

PTL 1 Japanese Unexamined Patent Application Publication No. 2023-54876

### SUMMARY OF INVENTION

### Technical Problem

Generally, when testing the susceptibility of bacteria to antimicrobial agents or the like using a microfluidic device, a test liquid containing a specimen is pressed into the microfluidic channel, allowed to act with the drug in the microfluidic channel, and then the specimen in the microfluidic device is observed with a microscope or the like. Therefore, if the observed region of the principal surface of the microfluidic device or a functional component such as a sensor is scratched or stained, the user may not be able to accurately observe the state of the specimen with a microscope or a functional component such as a sensor.

However, with conventional microfluidic devices, when the microfluidic devices are stacked for storage or delivery, the principal surface of the microfluidic device, including the observed region and functional components such as sensors, may come into direct contact with the microfluidic device above or below it. In such a case, the observed region of the principal surface of the microfluidic device may be scratched or stained, potentially leading to a state where the user cannot accurately observe the state of the specimen with a microscope or the like. Furthermore, a functional component such as a sensor on the principal surface of the microfluidic device may be scratched or stained, potentially leading to a state where the user cannot accurately grasp the state of the specimen with the functional component such as a sensor.

The present disclosure has been made to solve the problems as described above, and an object thereof is to protect a principal surface of a microfluidic device.

### Solution to Problem

A microfluidic device according to an aspect of the present disclosure includes a plate-shaped member, a projection disposed on the plate-shaped member, and a first projecting portion disposed on the plate-shaped member. The plate-shaped member has a substrate having a first surface and a second surface, and a plurality of microfluidic channels formed on one of the surfaces. The projection and the first projecting portion are disposed on the first surface of the substrate. A distance from the first surface to a farthest end of the first projecting portion is greater than a distance from the first surface to a farthest end of the projection.

### Advantageous Effects of Invention

In the microfluidic device of the present disclosure, a projecting portion (rib) is disposed on the principal surface of the microfluidic device. Therefore, the principal surface of the microfluidic device can be prevented from contacting another microfluidic device, and thus the principal surface of the microfluidic device can be protected.

### BRIEF DESCRIPTION OF DRAWINGS

FIG. 1 is a diagram showing an overall configuration of a testing apparatus in which a microfluidic device according to an embodiment is used.

FIG. 2 is a schematic diagram showing an example of a hardware configuration of a control unit.

FIG. 3 is a diagram showing an overall configuration of the microfluidic device according to the embodiment.

FIG. 4 is a diagram for explaining a microfluidic device of Modification 1.

FIG. 5 is a diagram for explaining a microfluidic device of Modification 2.

FIG. 6 is a diagram for explaining a microfluidic device of Modification 3.

FIG. 7 is a diagram for explaining a microfluidic device of Modification 4.

FIG. 8 is a diagram for explaining a microfluidic device of Modification 5.

FIG. 9 is a diagram for explaining a detailed structure of a storage unit which is an example of other equipment.

FIG. 10 is a diagram for explaining a structure of a bottom surface 3Z of the storage unit in FIG. 9.

FIG. 11 is a diagram for explaining a structure of a bottom surface 5Z of the storage unit in FIG. 9.

### DESCRIPTION OF EMBODIMENTS

Hereinafter, embodiments of the present disclosure will be described in detail with reference to the drawings. Note that identical or corresponding parts in the drawings are denoted by the same reference signs, and description thereof will not be repeated.

### Embodiment

### Configuration of Testing Apparatus

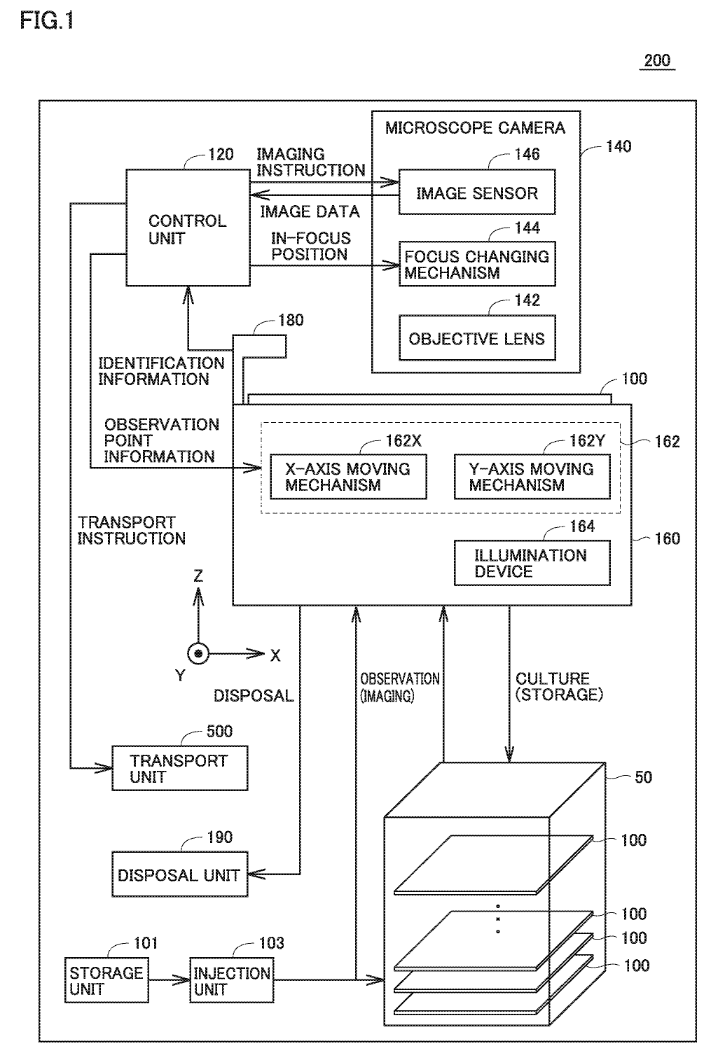

FIG. 1 is a diagram showing an overall configuration of a testing apparatus 200 in which a microfluidic device 100 according to the embodiment is used. The testing apparatus 200 is used, for example, for a drug susceptibility test.

The testing apparatus 200 images each of a plurality of observation points provided in the microfluidic device 100. At each of the plurality of observation points, an observation target obtained by bringing a test liquid containing bacteria, which is a biological factor, into contact with a drug is placed.

The testing apparatus 200 includes a control unit 120, a microscope camera 140, a stage 160, a reading unit 180, an incubator 50, a storage unit 101, an injection unit 103, a disposal unit 190, and a transport unit 500.

The stage 160 includes an imaging field-of-view changing mechanism 162 and an illumination device 164. The microfluidic device 100 is placed on the stage 160. The illumination device 164 provides transmitted illumination and irradiates the microfluidic device 100 on the stage 160 with light for observation.

In the following description, the normal direction of the stage 160 on which the microfluidic device 100 is placed is referred to as the Z-axis direction. Also, an arbitrary direction perpendicular to the Z-axis direction is referred to as the X-axis direction. Also, a direction perpendicular to the Z-axis direction and the Y-axis direction, and parallel to the principal surface of the stage 160 on which the microfluidic device 100 is placed, is referred to as the Y-axis direction.

The microfluidic device 100 is, for example, a substantially rectangular flat plate extending on the XY plane when viewed in plan from the positive Z-axis direction, and also has a height in the Z-axis direction. The microfluidic device 100 is disposed on the stage 160 such that its long sides extend in the X-axis direction and its short sides extend in the Y-axis direction. Note that the microfluidic device 100 may have other shapes, such as a circle, an ellipse, and a polygon.

The imaging field-of-view changing mechanism 162 changes the imaging field of view of the microscope camera 140. The imaging field-of-view changing mechanism 162 includes an X-axis moving mechanism 162X and a Y-axis moving mechanism 162Y. The X-axis moving mechanism 162X moves the microfluidic device 100 installed on the stage 160 in the X-axis direction. The Y-axis moving mechanism 162Y moves the microfluidic device 100 installed on the stage 160 in the Y-axis direction.

The microscope camera 140 includes an objective lens 142, a focus changing mechanism 144, and an image sensor 146. The objective lens 142 magnifies a part of the microfluidic device 100 installed on the stage 160. An arbitrary magnification is selected for the objective lens 142 according to the observation target.

The focus changing mechanism 144 changes the focus of the microscope camera 140. The focus changing mechanism 144 changes the focus of the microscope camera 140, for example, by changing the position of the objective lens 142 in the optical axis direction of the objective lens 142.

The image sensor 146 is a detector for capturing an image of the observation target magnified by the objective lens 142. The image sensor 146 is, for example, a CCD (Charge Coupled Device) image sensor, a CMOS (Complementary Metal Oxide Semiconductor) image sensor, or the like.

The reading unit 180 reads identification information of the microfluidic device 100. The reading unit 180 is, for example, a barcode reader, a QR code (registered trademark) reader, or a reader compatible with RF (Radio Frequency) tags, and is selected according to the type of identification code attached to the microfluidic device 100. The reading unit 180 transmits the read identification information to the control unit 120.

The incubator 50 cultures the bacteria in the microfluidic device 100 by storing the microfluidic device 100, into which the test liquid has been pressed, in an interior kept at a temperature suitable for culturing bacteria. The temperature suitable for culturing bacteria is, for example, about 37 degrees.

The storage unit 101 stores a new microfluidic device 100 before the test liquid is pressed into it. The injection unit 103 injects the test liquid into the new microfluidic device 100 before the test liquid is pressed into it. The disposal unit 190 stores the microfluidic device 100 that is waste, having been used for observation and no longer needed.

The transport unit 500 includes a fork (not shown) that places and moves the microfluidic device 100, and a drive unit (not shown) that drives the fork. The fork constitutes an example of a holding unit that holds the plate. In the transport unit 500, the drive unit drives the fork, thereby enabling the microfluidic device 100 to be moved to the storage unit 101, the injection unit 103, the incubator 50, the stage 160, and the disposal unit 190. Note that the microfluidic device 100 may be reciprocated multiple times between the incubator 50 and the stage 160 to observe the culture status of the bacteria over time. The drive unit is controlled by the control unit 120.

The control unit 120 controls the microscope camera 140 and the stage 160 based on the information read by the reading unit 180, and images the observation points of the microfluidic device 100. Further, the control unit 120 controls the transport unit 500 to move the microfluidic device 100.

### Configuration of Control Unit

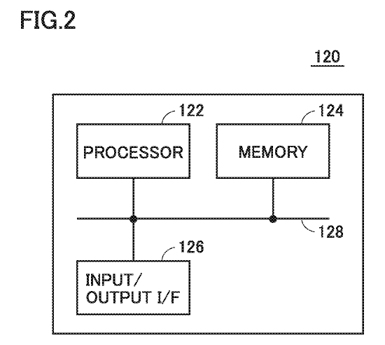

FIG. 2 is a schematic diagram showing an example of a hardware configuration of the control unit 120. The control unit 120 is configured, for example, according to a general-purpose computer architecture.

The control unit 120 includes, as main components, a processor 122, a memory 124, and an input/output interface (I/F) 126. These respective units are connected to be communicable with each other via a bus 128.

The memory 124 is realized by a RAM (Random Access Memory), a ROM (Read Only Memory), a non-volatile memory such as a flash memory, and a storage device such as a magnetic disk. The memory 124 stores programs executed by the processor 122, data used by the processor 122, and the like.

Specifically, the memory 124 stores identification information of the microfluidic device 100 acquired from the identification code attached to the microfluidic device 100, which is read by the reading unit 180. The identification information includes imaging conditions for imaging each observation point on the microfluidic device 100. The imaging conditions include observation point information indicating the position of the observation point to be imaged, and an in-focus position where the microscope camera 140 is in focus on the observation point to be imaged.

The input/output I/F 126 is an interface for exchanging various data between the control unit 120 and the focus changing mechanism 144, the image sensor 146, the imaging field-of-view changing mechanism 162, the reading unit 180, and the transport unit 500.

Specifically, the input/output I/F 126 receives the identification information of the microfluidic device 100 from the reading unit 180. The input/output I/F 126 outputs the observation point information, which indicates the position of the observation point to be imaged and is included in the input identification information, to the imaging field-of-view changing mechanism 162 of the stage 160. Further, the input/output I/F 126 outputs the in-focus position, which corresponds to the observation point to be imaged and is included in the input identification information, to the focus changing mechanism 144 of the microscope camera 140.

Further, the input/output I/F 126 outputs an imaging instruction to the image sensor 146 of the microscope camera 140. Further, the input/output I/F 126 receives image data from the image sensor 146 of the microscope camera 140. Furthermore, the input/output I/F 126 outputs a transport instruction to the transport unit 500.

The processor 122 is typically an arithmetic processing unit such as a CPU (Central Processing Unit) or an MPU (Micro Processing Unit). The processor 122 reads and executes a program stored in the memory 124, thereby controlling the operation of each unit of the testing apparatus 200.

Specifically, the processor 122 drives the imaging field-of-view changing mechanism 162 based on the observation point information indicating the position of the observation point to be imaged, to move the stage 160 so that the observation point is included in the imaging field of view. Further, the processor 122 drives the focus changing mechanism 144 of the microscope camera 140 to move the microscope camera 140 to the in-focus position.

Further, the processor 122 uses the image sensor 146 of the microscope camera 140 to capture an image of the observation point to be imaged by the microscope camera 140. Furthermore, the processor 122 drives the transport unit 500 to transport the microfluidic device 100 before observation from the injection unit 103 or the incubator 50 to the stage 160. Furthermore, the processor 122 drives the transport unit 500 to transport the microfluidic device 100 after observation from the stage 160 to the disposal unit 190 or the incubator 50. Note that although the example in FIG. 2 illustrates a configuration with a single processor, the control unit 120 may have a configuration including multiple processors.

### Configuration of Microfluidic Device

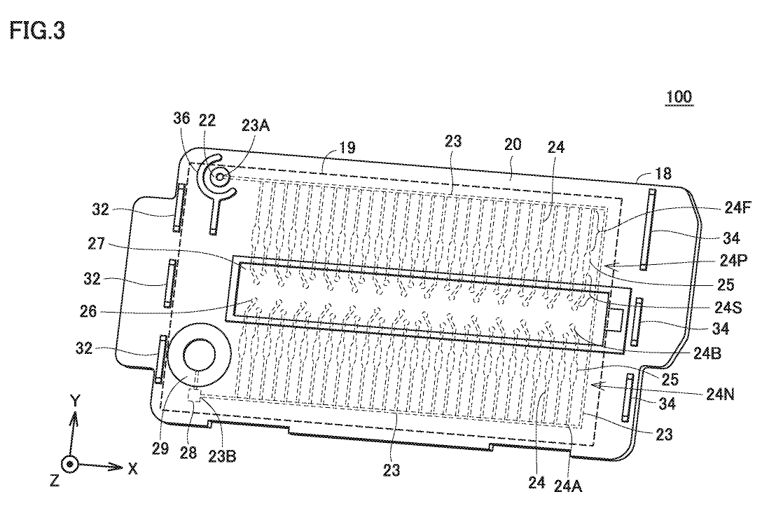

FIG. 3 is a diagram showing an overall configuration of the microfluidic device 100 according to the embodiment. FIG. 3 shows a perspective view of the microfluidic device 100. As shown in FIG. 3, the microfluidic device 100 includes a plate-shaped member 20. The plate-shaped member 20 may be substantially rectangular, and a part of its sides and corners may be cut out. The plate-shaped member 20 includes a substrate 18 and a film 19. The substrate 18 includes a channel structure on its surface in the negative Z-axis direction. The film 19 covers the channel structure formed on the surface of the substrate 18 in the negative Z-axis direction from the negative Z-axis direction.

The channel structure includes an opening 22, a main channel 23, a microfluidic channel 24, a reservoir 25, an opening 26, a gas permeable membrane 27, a recovery unit 28, and an opening 29. Note that the microfluidic device 100 may have a configuration in which the opening 26 is not formed.

The opening 22 is formed at one end of the main channel 23 on the surface of the substrate 18 in the positive Z-axis direction, and communicates with the main channel 23. A test liquid is pressed from the opening 22 into the main channel 23 using fluid pressure. A hole for injecting the test liquid into the microfluidic device 100 with a syringe or the like is formed in a portion of the opening 22 that protrudes from the plate-shaped member 20. The test liquid pressed into the main channel 23 is further pressed into the microfluidic channels 24 arranged in the Y-axis direction. In the present embodiment, air pressure is used as the fluid pressure. The hole in the protruding portion of the opening 22 is formed, for example, in a circular shape. The diameter of the hole in the protruding portion of the opening 22 is, for example, 5 μm to 5 mm. In the present embodiment, the opening 22 is formed at one end of one main channel 23. The one main channel 23 is disposed at a position surrounding the outside of the plurality of microfluidic channels 24.

The main channel 23 has an inlet-side end 23A where the opening 22 is formed, and an outlet-side end 23B located on the opposite side to the inlet-side end 23A. The main channel 23 extending from the opening 22 further branches into a plurality of microfluidic channels 24. The main channel 23 is fluidly connected to the plurality of microfluidic channels 24. The test liquid flowing in from the opening 22 flows through the main channel 23 to the plurality of branched microfluidic channels 24. The cross-sections of the main channel 23 and the microfluidic channel 24 are rectangular, and the width of the main channel 23 and the microfluidic channel 24 is, for example, 1 μm to 1 mm.

However, the internal dimension in the Z-axis direction differs between the main channel 23 and the microfluidic channel 24. For example, while the internal dimension in the Z-axis direction of the main channel 23 is 0.5 mm, the internal dimension in the Z-axis direction of the microfluidic channel 24 is as small as 0.025 mm. That is, the length in the Z-axis direction of the cavity portion from the boundary between the film 19 and the substrate 18 to the bottom of the channel differs between the main channel 23 and the microfluidic channel 24.

Therefore, the flow resistance of the microfluidic channel 24 is greater than that of the main channel 23. By making the flow resistance of the microfluidic channel 24 greater than that of the main channel 23, the test liquid flowing in from the opening 22 can, as described later, once fill the main channel 23 and then flow into the plurality of microfluidic channels 24 almost simultaneously.

In the present embodiment, 32 microfluidic channels 24 arranged side by side in the X-axis direction form one group, and two groups are arranged side by side in the Y-axis direction. That is, the microfluidic device 100 has a group 24P in the positive Y-axis direction and a group 24N in the negative Y-axis direction. Each of the plurality of microfluidic channels 24 has a first side end 24A communicating with the main channel 23, and a second side end 24B located on the opposite side to the first side end 24A.

Each of the plurality of microfluidic channels 24 included in the group 24P is connected to the main channel 23 disposed in the positive Y-axis direction of the microfluidic device 100. Therefore, the test liquid branched from the main channel 23 flows in the negative Y-axis direction.

On the other hand, each of the plurality of microfluidic channels 24 included in the group 24N is connected to the main channel 23 disposed in the negative Y-axis direction of the microfluidic device 100. Therefore, the plurality of microfluidic channels 24 included in the group 24N are arranged in the Y-axis direction, and the test liquid branched from the main channel 23 flows in the positive Y-axis direction.

A substantially rectangular parallelepiped reservoir 25 is provided in the middle of each microfluidic channel 24. Therefore, the test liquid flowing in from the opening 22 flows to each reservoir 25 via the main channel 23 and the first half portion 24F of the microfluidic channel 24.

The reservoir 25 is connected to the opening 22 via the main channel 23 and stores the test liquid flowing in from the opening 22. A drug is placed in the reservoir 25 in advance. That is, the drug is placed in the reservoir 25 before the test liquid flows into the reservoir 25. The test liquid reacts with the drug in the reservoir 25. The drug is, for example, an antimicrobial agent. The drug may be solid or liquid.

In the example of FIG. 3, 60 (= 30 × 2) reservoirs 25 are formed in the plate-shaped member 20. The volumes of the test liquid stored in the 60 reservoirs 25 are identical to each other. On the other hand, the type of drug and the amount of drug placed in the 60 reservoirs 25 may be identical to or different from each other.

A second half portion 24S of the microfluidic channel is disposed further from the reservoir 25 to the opening 26. The second half portion 24S of the microfluidic channel is disposed along the Y-axis direction, has one end connected to the reservoir 25, and has the opening 26 formed at the other end (the second side end 24B). The second half portion 24S of the microfluidic channel causes the test liquid that has flowed into the reservoir 25 to flow further to the opening 26.

At the opening 26, a hole is formed for discharging air from within the main channel 23 and the microfluidic channel 24 to the outside of the microfluidic device 100, and for filling the test liquid up to the second side end 24B of the microfluidic channel. The opening 26 is formed, for example, in a circular shape when viewed in plan from the positive Z-axis direction. The diameter of the hole of the opening 26 is, for example, 5 μm to 5 mm. The hole of the opening 26 is covered with a gas permeable membrane 27. Specifically, in FIG. 3, 30 openings 26 connected to the plurality of microfluidic channels 24 included in the group 24P and 30 openings 26 connected to the plurality of microfluidic channels 24 included in the group 24N are disposed facing each other.

Therefore, 60 (= 30 × 2) openings 26 are formed along the X-axis direction in the central portion of the microfluidic device 100. These 60 openings 26 are covered by one sheet of gas permeable membrane 27. Note that the gas permeable membrane 27 does not have to cover the 60 openings 26 with one sheet, but may be divided into two sheets to cover the 30 openings 26 included in the group 24P and the 30 openings 26 included in the group 24N. Further, the gas permeable membrane 27 may cover at least one of the 60 openings 26.

The gas permeable membrane 27 has a function of transmitting gas and not transmitting liquid. Examples of the material for the gas permeable membrane 27 include polytetrafluoroethylene (PTFE) and the like. The gas permeable membrane 27 preferably has water repellency. The thickness of the gas permeable membrane 27 is 1 mm or less. The gas permeable membrane 27 is fixed to the plate-shaped member 20 by adhesion with an adhesive, ultrasonic welding, or the like. Examples of the adhesive include photocurable resins, thermosetting resins, and pressure-sensitive resins. By disposing the gas permeable membrane 27, it is possible to fill the main channel 23 and the microfluidic channel 24 with the test liquid while discharging air, which existed in the main channel 23 and the microfluidic channel 24 before the test, from the opening 26 to the outside of the microfluidic device 100, and also to prevent the test liquid from flowing out of the microfluidic device 100.

The main channel 23 connected to the opening 22 is disposed so as to surround the outside of the microfluidic channel 24, and is connected to a recovery unit 28. The recovery unit 28 is provided at the outlet-side end 23B of the main channel 23. The recovery unit 28 recovers a part of the test liquid that has flowed into the main channel 23 from the opening 22. The recovery unit 28 recovers a part of the test liquid that has flowed into the main channel 23 from the opening 22.

The recovery unit 28 is formed in a rectangular parallelepiped shape. The length of one side of the recovery unit 28 is, for example, 10 μm to 10 mm. A member that absorbs moisture, such as a sponge (water-absorbing member), may be provided in the recovery unit 28. This can prevent backflow from the recovery unit 28 to the main channel 23, and also prevent evaporation of the test liquid from the main channel 23.

The opening 29 is formed on the surface of the substrate 18 in the positive Z-axis direction and is connected to the end of the recovery unit 28. The test liquid can flow from the opening 22 to the opening 29 through the main channel 23 and the recovery unit 28. At the opening 29, a hole is formed for discharging the test liquid in the main channel 23 and the recovery unit 28 to the outside of the microfluidic device 100.

The opening 29 can be switched between opening or closing the hole by an opening/closing unit (not shown) of the testing apparatus 200. By closing the opening 29, the test liquid that has flowed into the main channel 23 can be prevented from being discharged to the recovery unit 28 and the opening 29. On the other hand, by opening the opening 29, the test liquid remaining in the main channel 23 can be discharged to the recovery unit 28 and recovered.

Generally, when testing the susceptibility of bacteria to antimicrobial agents or the like using a microfluidic device, a test liquid containing a specimen is pressed into the microfluidic channel, allowed to act with the drug in the microfluidic channel, and then the specimen in the microfluidic device is observed with a microscope or the like. Therefore, if the observed region of the principal surface of the microfluidic device or a functional component such as a sensor is scratched or stained, the user may not be able to accurately observe the state of the specimen with a microscope or a functional component such as a sensor.

However, with conventional microfluidic devices, when the microfluidic devices are stacked for storage or delivery, the principal surface of the microfluidic device, including the observed region and functional components such as sensors, sometimes comes into direct contact with the microfluidic device above or below it.

Therefore, the microfluidic device 100 of the present disclosure is further provided with ribs 32, 34, 36 that protrude from the principal surface. The rib 32 is disposed on the plate-shaped member 20 at the end in the negative X-axis direction so as to extend in the Y-axis direction. In the example of FIG. 3, three ribs 32 are disposed on the same straight line in the Y-axis direction.

Further, the rib 34 is disposed on the plate-shaped member 20 at the end in the positive X-axis direction so as to extend in the Y-axis direction. In the example of FIG. 3, three ribs 34 are disposed on the same straight line in the Y-axis direction. The ribs 32 and 34 preferably have the same height in the Z-axis direction.

By providing the ribs 32 and 34, when a plurality of microfluidic devices 100 are stacked, only the ribs 32 and 34 come into contact with the surface on the negative Z-axis direction side of another microfluidic device 100. Therefore, the principal surface of the microfluidic device 100 can be prevented from contacting another microfluidic device 100, and the principal surface of the microfluidic device 100 can be protected.

Further, conventional microfluidic devices often have a flat principal surface, and when stacking microfluidic devices before and during use, the principal surfaces of the overlapping microfluidic devices may overlap with almost no gap. In such a case, it becomes difficult to grip the microfluidic devices individually, and it can be difficult to pull out one microfluidic device from a plurality of stacked microfluidic devices.

By providing the ribs 32 and 34, a gap is created between the principal surfaces of the microfluidic devices 100 when a plurality of microfluidic devices 100 are stacked, making it easier to pull out the microfluidic devices one by one. In order to protect the opening 22 protruding from the plate-shaped member 20 from the corner or the like of an upper microfluidic device when pulling out the microfluidic device, the microfluidic device 100 also includes a rib 36.

The rib 36 includes an arc-shaped portion so as to surround the opening 22 except on the main channel 23, and a portion extending in the negative Y-axis direction from the arc-shaped portion. The length of the rib 36 in the Z-axis direction may be the same as that of the ribs 32 and 34, or may be smaller than that of the ribs 32 and 34.

As described above, by providing the rib 32, 34, or 36, when a plurality of microfluidic devices 100 are stacked, the principal surface of the microfluidic device 100 can be prevented from contacting another microfluidic device 100. Therefore, the principal surface of the microfluidic device 100 can be protected.

### Modification 1

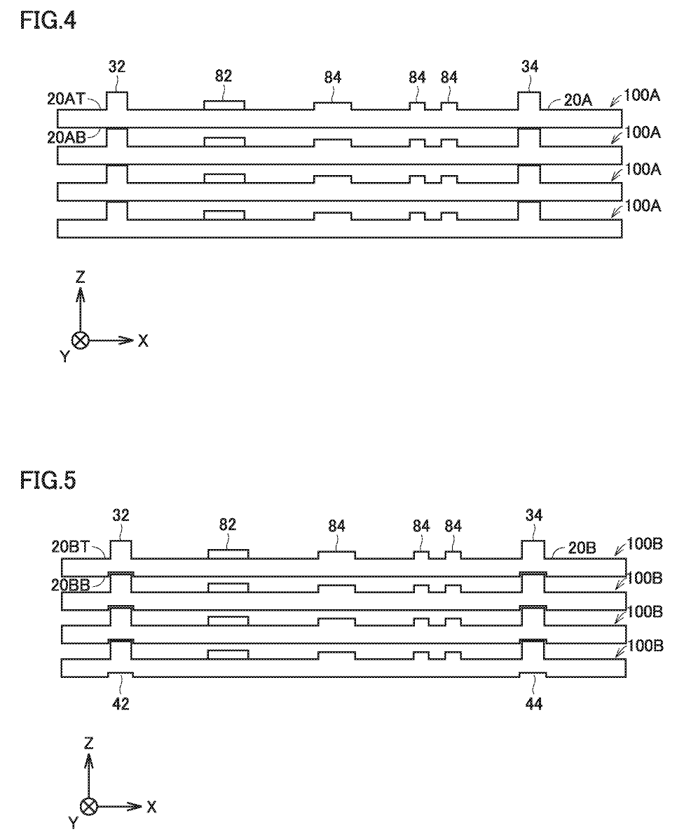

FIG. 4 is a diagram for explaining a microfluidic device 100A of Modification 1. FIG. 4 shows a view, viewed from the negative Y-axis direction, of a state in which microfluidic devices 100A, in which ribs are disposed on a surface 20AT on the positive Z-axis direction side of a plate-shaped member 20A, are stacked in the Z-axis direction. The microfluidic device 100A includes, in addition to the configuration of the microfluidic device 100 shown in FIG. 3, a functional component and a projection 84. The projection 84 is, for example, the opening 22. A surface 20AB on the negative Z-axis direction side of the plate-shaped member 20A of the microfluidic device 100A is flat.

The functional component includes a sensor 82, an RFID (Radio Frequency Identification), and the like. Identification information of each microfluidic device 100A is stored in the RFID. The identification information is, for example, an identification number of the microfluidic device 100A, or information such as the type of drug placed in the microfluidic device 100A in advance. The identification information is also used for measuring the number of stacked microfluidic devices 100A. Note that instead of RFID, the identification information may be stored, for example, in a barcode, a QR code (registered trademark), or the like.

Hereinafter, the distance in the Z-axis direction from the surface 20AT of the plate-shaped member, on which the rib is disposed, to the end of the rib in the Z-axis direction is referred to as the height of the rib. Also, hereinafter, the distance in the Z-axis direction from the surface of the plate-shaped member, on which the sensor is disposed, to the end of the sensor in the Z-axis direction is referred to as the height of the sensor. Similarly, hereinafter, the distance in the Z-axis direction from the surface of the plate-shaped member, on which the projection is disposed, to the end of the projection in the Z-axis direction is referred to as the height of the projection. Note that the "sensor" in the embodiment corresponds to the "functional component" in the present disclosure.

In the microfluidic device 100A, the height of the rib 32 corresponds to the distance between the plate-shaped members 20A. The height of the ribs 32, 34 is set such that the distance between the plate-shaped members 20A is greater than the height of the sensor 82 and the height of the projection 84. By doing so, the principal surface of the microfluidic device 100A, including the observed region and functional components such as sensors, can be prevented from contacting another microfluidic device. Therefore, the principal surface of the microfluidic device 100A can be protected.

Further, when the microfluidic devices 100A are stacked on top of each other, a gap is formed between adjacent microfluidic devices 100A. By doing so, it becomes possible for a sensor to recognize the boundary between overlapping microfluidic devices, enabling automatic transport of individual microfluidic devices and automatic measurement of the number of stacked microfluidic devices.

### Modification 2

FIG. 5 is a diagram for explaining a microfluidic device 100B of Modification 2. FIG. 5 shows a view, viewed from the negative Y-axis direction, of a state in which microfluidic devices 100B, in which recessed portions 42, 44 are formed on a surface 20BB on the negative Z-axis direction side of a plate-shaped member 20B, are stacked. The microfluidic device 100B includes the configuration of the microfluidic device 100A, and in addition, the recessed portions 42, 44 are formed. A surface 20BT on the positive Z-axis direction side of the plate-shaped member 20B of the microfluidic device 100B is provided with the same configuration as the microfluidic device 100A.

In the microfluidic device 100B, the rib 32 is disposed on the surface 20BT of the plate-shaped member 20B, and the recessed portion 42 is formed on the surface 20BB of the plate-shaped member 20B. When viewed in plan from the Z-axis direction, the rib 32 on the surface 20BT of the plate-shaped member 20B overlaps with the recessed portion 42 on the surface 20BB of the plate-shaped member 20B. Similarly, a recessed portion 44 is formed on the surface 20BB corresponding to the rib 34 disposed on the surface 20BT. By doing so, when the microfluidic devices 100B are stacked, the rib 32 fits into the recessed portion 42, and the rib 34 fits into the recessed portion 44.

When the distance in the Z-axis direction from the surface of the plate-shaped member, on which the recessed portion is formed, to the bottom of the recessed portion in the Z-axis direction is defined as the depth of the recessed portion, in the microfluidic device 100B, the value obtained by subtracting the depth of the recessed portion 42 from the height of the rib 32, and the value obtained by subtracting the depth of the recessed portion 44 from the height of the rib 34, become the distance between the two stacked plate-shaped members 20. The height of the ribs 32, 34 and the depth of the recessed portions 42, 44 are set such that the distance between the plate-shaped members 20 is greater than the height of the sensor 82 and the height of the projection 84.

By doing so, when a plurality of microfluidic devices 100B are stacked, the principal surface of the microfluidic device 100B can be prevented from contacting the principal surface of the plate-shaped member in an adjacent other microfluidic device 100B, and therefore the principal surface of the microfluidic device can be protected.

Further, when the microfluidic devices 100B are stacked on top of each other, a gap is formed between adjacent microfluidic devices 100B. By doing so, it becomes possible for a sensor to recognize the boundary between overlapping microfluidic devices, enabling automatic transport of individual microfluidic devices and automatic measurement of the number of stacked microfluidic devices.

### Modification 3

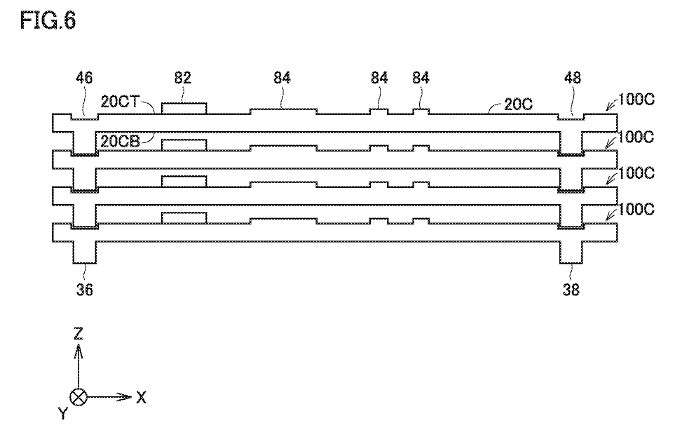

FIG. 6 is a diagram for explaining a microfluidic device 100C of Modification 3. FIG. 6 shows a view, viewed from the negative Y-axis direction, of a state in which microfluidic devices 100C, in which ribs 36, 38 are disposed on a surface 20CB on the negative Z-axis direction side of a plate-shaped member 20C, and recessed portions 46, 48 are formed on a surface 20CT on the positive Z-axis direction side of the plate-shaped member 20, are stacked. In the microfluidic device 100C, the surface of the plate-shaped member 20 on which each of the ribs and the recessed portions is formed is different from the surface of the plate-shaped member 20 on which each of the ribs and the recessed portions is formed in the microfluidic device 100B.

The surface 20CT on the positive Z-axis direction side of the plate-shaped member 20C of the microfluidic device 100C is provided with the same configuration as the surface 20CB on the negative Z-axis direction side of the plate-shaped member 20B of the microfluidic device 100B. Further, the surface 20CB on the negative Z-axis direction side of the plate-shaped member 20C of the microfluidic device 100C is provided with the same configuration as the surface 20BT on the negative Z-axis direction side of the plate-shaped member 20B of the microfluidic device 100B.

In the microfluidic device 100C, the rib 36 is disposed on the surface 20CB of the plate-shaped member 20C, and the recessed portion 46 is formed on the surface 20CT of the plate-shaped member 20C. When viewed in plan from the Z-axis direction, the rib 36 on the surface 20CB of the plate-shaped member 20C overlaps with the recessed portion 46 on the surface 20CT of the plate-shaped member 20C. Similarly, a recessed portion 48 is formed on the surface 20CT corresponding to the rib 38 disposed on the surface 20CB. By doing so, when the microfluidic devices 100C are stacked, the rib 36 fits into the recessed portion 46, and the rib 38 fits into the recessed portion 48.

In the microfluidic device 100C, the value obtained by subtracting the depth of the recessed portion 46 from the height of the rib 36, and the value obtained by subtracting the depth of the recessed portion 48 from the height of the rib 38, become the distance between the two stacked plate-shaped members 20. The height of the ribs 36, 38 and the depth of the recessed portions 46, 48 are set such that the distance between the plate-shaped members 20 is greater than the height of the sensor 82 and the height of the projection 84.

By doing so, when a plurality of microfluidic devices 100C are stacked, the principal surface of the microfluidic device 100C can be prevented from contacting the principal surface of the plate-shaped member in an adjacent other microfluidic device 100C, and therefore the principal surface of the microfluidic device can be protected.

Note that ribs may be provided on both surfaces of the substrate in one plate-shaped member. Also, similarly, recessed portions may be formed on both surfaces of the substrate in one plate-shaped member. By doing so, not only the principal surface of the microfluidic device but also the other surface can be protected.

Further, when the microfluidic devices 100C are stacked on top of each other, a gap is formed between adjacent microfluidic devices 100C. By doing so, it becomes possible for a sensor to recognize the boundary between overlapping microfluidic devices, enabling automatic transport of individual microfluidic devices and automatic measurement of the number of stacked microfluidic devices.

### Modification 4

In the storage unit 101 and the incubator 50, the user pulls out one microfluidic device to use from a state where a plurality of microfluidic devices are stored stacked. In Modification 4, an example of the arrangement of ribs and recessed portions suitable for pulling out one microfluidic device from a stacked state will be described.

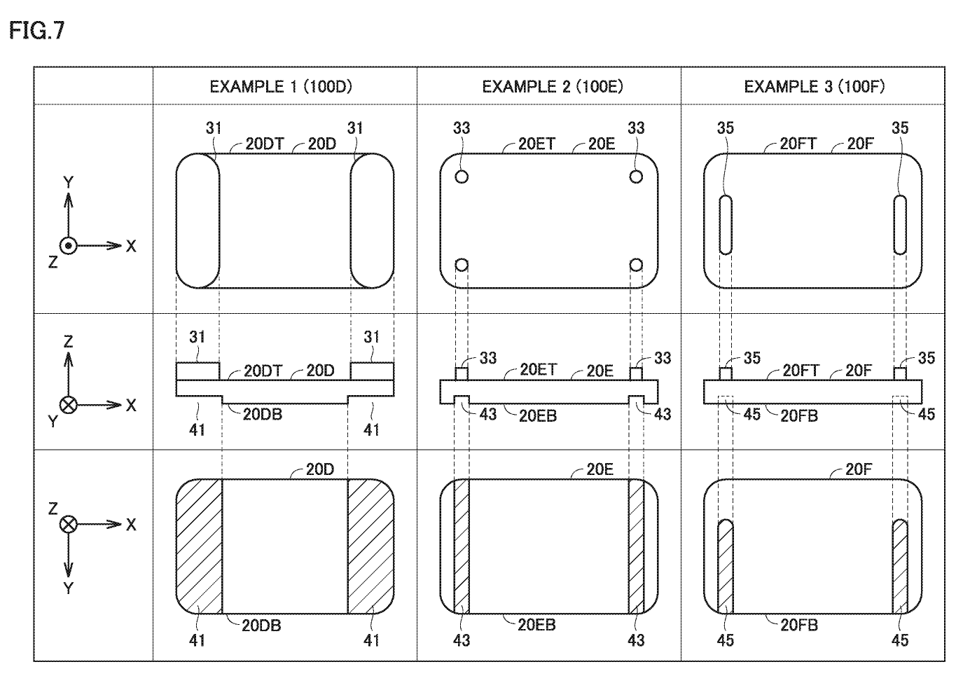

FIG. 7 is a diagram for explaining a microfluidic device of Modification 4. FIG. 7 shows configurations of three types of microfluidic devices 100D to 100F suitable for being pulled out and used. Examples 1 to 3 in FIG. 7 correspond to the microfluidic devices 100D to 100F, respectively. In each microfluidic device, the upper diagram is a diagram when the plate-shaped member is viewed in plan from the positive Z-axis direction. The middle diagram is a diagram when the plate-shaped member is viewed in plan from the negative Y-axis direction. The lower diagram is a diagram when the plate-shaped member is viewed in plan from the negative Z-axis direction.

In the microfluidic device 100D of Example 1, on a surface 20DT in the positive Z-axis direction of the plate-shaped member 20D, ribs 31 extending in the Y-axis direction are disposed along the sides at both ends in the X-axis direction. As shown in the upper diagram, when viewed in plan from the positive Z-axis direction, the rib 31 is rectangular with arc-shaped corners.

As shown in the middle diagram, the rib 31 protrudes in the positive Z-axis direction and extends flatly in the Y-axis direction. Also, as shown in the middle and lower diagrams, on a surface 20DB in the negative Z-axis direction of the plate-shaped member 20D, a recessed portion 41 is formed at a position corresponding to the rib 31. The length of the rib 31 in the X-axis direction is shorter than the length of the recessed portion 41 in the X-axis direction. That is, when viewed in plan from the Z-axis direction, the rib 31 overlaps with the recessed portion 41. By doing so, when the plate-shaped members 20D are stacked in the Z-axis direction, the rib 31 fits into the recessed portion 41.

As shown in the lower diagram, the recessed portion 41 is formed on the surface 20DB of the plate-shaped member, along the sides at both ends in the X-axis direction of the plate-shaped member 20D. The recessed portion 41 is formed in a linear groove shape penetrating from one side to the other side along the X-axis direction of the plate-shaped member 20D. That is, the recessed portion 41 is formed to extend linearly to the end of the substrate of the plate-shaped member 20D. Note that one end of the recessed portion 41 in the Y-axis direction does not have to penetrate.

By forming the ribs and the recessed portions in this way, when the microfluidic devices 100D are stacked in the Z-axis direction, one microfluidic device 100D can be pulled out in the Y-axis direction from among the plurality of stacked microfluidic devices 100D. Therefore, one microfluidic device can be taken out from a plurality of stacked microfluidic devices while protecting the principal surface of the microfluidic device.

Note that an inclination may be formed at the end of the rib 31 in the Y-axis direction. By forming the rib 31 in this way, when pulling out one microfluidic device 100D from a plurality of stacked microfluidic devices 100D, it can be pulled out more smoothly without catching.

Further, when the microfluidic devices 100D are stacked on top of each other, a gap is formed between adjacent microfluidic devices 100D. By doing so, it becomes possible for a sensor to recognize the boundary between overlapping microfluidic devices, enabling automatic transport of individual microfluidic devices and automatic measurement of the number of stacked microfluidic devices.

In the microfluidic device 100E of Example 2, on a surface 20ET in the positive Z-axis direction of the plate-shaped member 20E, ribs 33 are disposed near the four corners of the plate-shaped member 20E. As shown in the upper diagram, when viewed in plan from the positive Z-axis direction, the rib 33 is circular. Note that the rib 33 may be a triangle, a quadrangle, or another polygon.

As shown in the middle diagram, the rib 33 protrudes in the positive Z-axis direction, and a recessed portion 43 is formed on a surface 20EB in the negative Z-axis direction of the plate-shaped member 20E, at a position behind the rib 33. Also, as shown in the middle and lower diagrams, on the surface 20EB in the negative Z-axis direction of the plate-shaped member 20E, the recessed portion 43 is formed at a position corresponding to the rib 33. The length of the rib 33 in the X-axis direction is smaller than the length of the recessed portion 43 in the X-axis direction. That is, when viewed in plan from the Z-axis direction, the rib 33 overlaps with the recessed portion 43. By doing so, when the plate-shaped members 20E are stacked in the Z-axis direction, the rib 33 fits into the recessed portion 43.

As shown in the lower diagram, the recessed portion 43 is formed on the surface 20EB of the plate-shaped member, along the sides at both ends in the X-axis direction of the plate-shaped member 20E. The recessed portion 43 is formed in a linear groove shape penetrating from one side to the other side along the X-axis direction of the plate-shaped member 20E. That is, the recessed portion 43 is formed to extend linearly to the end of the substrate of the plate-shaped member 20E. Note that one end of the recessed portion 43 in the Y-axis direction does not have to penetrate.

By forming the ribs and the recessed portions in this way, when the microfluidic devices 100E are stacked in the Z-axis direction, one microfluidic device 100E can be pulled out in the Y-axis direction from among the plurality of stacked microfluidic devices 100E. Therefore, one microfluidic device can be taken out from a plurality of stacked microfluidic devices while protecting the principal surface of the microfluidic device.

Note that an inclination may be formed at the end of the rib 33 in the Y-axis direction. By forming the rib 33 in this way, when pulling out one microfluidic device 100E from a plurality of stacked microfluidic devices 100E, it can be pulled out more smoothly without catching.

Further, when the microfluidic devices 100E are stacked on top of each other, a gap is formed between adjacent microfluidic devices 100E. By doing so, it becomes possible for a sensor to recognize the boundary between overlapping microfluidic devices, enabling automatic transport of individual microfluidic devices and automatic measurement of the number of stacked microfluidic devices.

In the microfluidic device 100F of Example 3, on a surface 20FT in the positive Z-axis direction of the plate-shaped member 20F, ribs 35 extending in the Y-axis direction are disposed along the sides at both ends in the X-axis direction. As shown in the upper diagram, when viewed in plan from the positive Z-axis direction, the rib 35 is rectangular with arc-shaped corners.

As shown in the middle diagram, the rib 35 protrudes in the positive Z-axis direction and extends flatly in the Y-axis direction. Also, as shown in the middle and lower diagrams, on a surface 20FB in the negative Z-axis direction of the plate-shaped member 20F, a recessed portion 45 is formed at a position corresponding to the rib 35. The length of the rib 35 in the X-axis direction is shorter than the length of the recessed portion 45 in the X-axis direction. That is, when viewed in plan from the Z-axis direction, the rib 35 overlaps with the recessed portion 45. By doing so, when the plate-shaped members 20F are stacked in the Z-axis direction, the rib 35 fits into the recessed portion 45.

As shown in the lower diagram, the recessed portion 45 is formed on the surface 20FB of the plate-shaped member, along the sides at both ends in the X-axis direction of the plate-shaped member 20F. The recessed portion 45 is formed in a linear groove shape extending from one side to the other side along the X-axis direction of the plate-shaped member 20F. That is, the recessed portion 45 is formed to extend linearly to the end of the substrate of the plate-shaped member 20F. Note that the end of the recessed portion 45 in the negative Y-axis direction does not penetrate.

By forming the ribs and the recessed portions in this way, when the microfluidic devices 100F are stacked in the Z-axis direction, one microfluidic device 100F can be pulled out in the Y-axis direction from among the plurality of stacked microfluidic devices 100F. Therefore, one microfluidic device can be taken out from a plurality of stacked microfluidic devices while protecting the principal surface of the microfluidic device.

Note that an inclination may be formed at the end of the rib 35 in the Y-axis direction. By forming the rib 35 in this way, when pulling out one microfluidic device 100F from a plurality of stacked microfluidic devices 100F, it can be pulled out more smoothly without catching.

Further, when the microfluidic devices 100F are stacked on top of each other, a gap is formed between adjacent microfluidic devices 100F. By doing so, it becomes possible for a sensor to recognize the boundary between overlapping microfluidic devices, enabling automatic transport of individual microfluidic devices and automatic measurement of the number of stacked microfluidic devices.

### Modification 5

In the storage unit 101 and the incubator 50, the user pulls out one microfluidic device to use from a state where a plurality of microfluidic devices are stored stacked. In Modification 5, an example of the arrangement of ribs and recessed portions suitable for taking out the single topmost microfluidic device from a state where the microfluidic devices are fixed and stacked will be described.

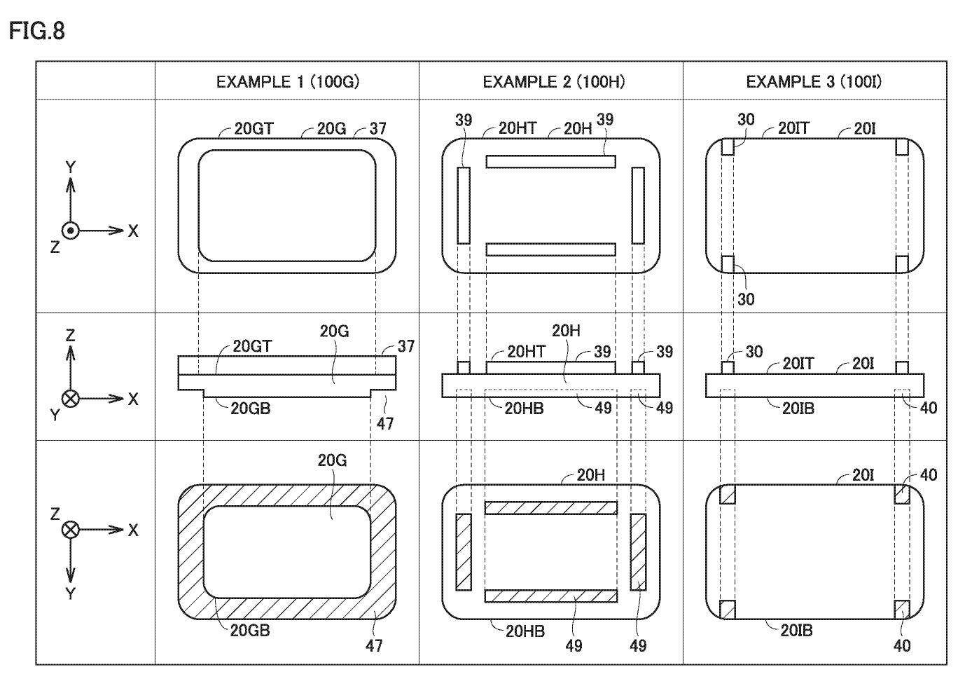

FIG. 8 is a diagram for explaining a microfluidic device of Modification 5. FIG. 8 shows configurations of three types of microfluidic devices 100G to 100I suitable for being used fixed. Examples 1 to 3 in FIG. 8 correspond to the microfluidic devices 100G to 100I, respectively. In each microfluidic device, the upper diagram is a diagram when the plate-shaped member is viewed in plan from the positive Z-axis direction. The middle diagram is a diagram when the plate-shaped member is viewed in plan from the negative Y-axis direction. The lower diagram is a diagram when the plate-shaped member is viewed in plan from the negative Z-axis direction.

In the microfluidic device 100G of Example 1, on a surface 20GT in the positive Z-axis direction of the plate-shaped member 20G, a rib 37 is disposed along the end side so as to go around the end of the plate-shaped member 20G. That is, the rib 37 is disposed along the periphery of one surface of the substrate of the plate-shaped member 20G. As shown in the upper diagram, when viewed in plan from the positive Z-axis direction, the rib 37 is in the shape of a frame that is rectangular with arc-shaped corners.

As shown in the middle diagram, the rib 37 protrudes in the positive Z-axis direction and extends flatly in the X-axis direction and the Y-axis direction. Also, as shown in the middle and lower diagrams, on a surface 20GB in the negative Z-axis direction of the plate-shaped member 20G, a recessed portion 47 is formed at a position corresponding to the rib 37. The length in the X-axis direction of the portion of the rib 37 extending in the Y-axis direction is shorter than the length in the X-axis direction of the portion of the recessed portion 47 extending in the Y-axis direction. Also, the length in the Y-axis direction of the portion of the rib 37 extending in the X-axis direction is shorter than the length in the Y-axis direction of the portion of the recessed portion 47 extending in the X-axis direction. That is, when viewed in plan from the Z-axis direction, the rib 37 overlaps with the recessed portion 47. By doing so, when the plate-shaped members 20G are stacked in the Z-axis direction, the rib 37 fits into the recessed portion 47.

As shown in the lower diagram, the recessed portion 47 is formed at the edge of the plate-shaped member 20G so as to go all the way around. That is, the recessed portion 47 is formed along the periphery of the surface of the substrate of the plate-shaped member 20G on which the rib 37 is not disposed.

By forming the ribs and the recessed portions in this way, the microfluidic devices 100G can be fixedly stacked in the Z-axis direction, and the single topmost microfluidic device 100G can be taken out. Therefore, one microfluidic device can be taken out from a plurality of fixedly stacked microfluidic devices while protecting the principal surface of the microfluidic device.

Further, when the microfluidic devices 100G are stacked on top of each other, a gap is formed between adjacent microfluidic devices 100G. By doing so, it becomes possible for a sensor to recognize the boundary between overlapping microfluidic devices, enabling automatic transport of individual microfluidic devices and automatic measurement of the number of stacked microfluidic devices.

In the microfluidic device 100H of Example 2, on a surface 20HT in the positive Z-axis direction of the plate-shaped member 20H, four ribs 39 extending along the end sides of the plate-shaped member 20H are disposed. As shown in the upper diagram, when viewed in plan from the positive Z-axis direction, the rib 39 is rectangular. Note that the rib 39 may be a triangle, a circle, a rectangle with arc-shaped corners, or any other shape.

As shown in the middle diagram, the rib 39 protrudes in the positive Z-axis direction and extends flatly in the Y-axis direction. Also, as shown in the middle and lower diagrams, on a surface 20HB in the negative Z-axis direction of the plate-shaped member 20H, a recessed portion 49 is formed at a position corresponding to the rib 39. The length in the X-axis direction of each rib 39 is shorter than the length in the X-axis direction of each recessed portion 49 corresponding to each rib 39. Also, the length in the Y-axis direction of each rib 39 is shorter than the length in the Y-axis direction of each recessed portion 49 corresponding to each rib 39. That is, when viewed in plan from the Z-axis direction, the rib 39 overlaps with the recessed portion 49. By doing so, when the plate-shaped members 20H are stacked in the Z-axis direction, the rib 39 fits into the recessed portion 49.

As shown in the lower diagram, four recessed portions 49 are formed in a direction parallel to the end sides of the plate-shaped member 20H. That is, the recessed portion 49 is formed at a position other than the end of the substrate of the plate-shaped member 20H.

By forming the ribs and the recessed portions in this way, the microfluidic devices 100H can be fixedly stacked in the Z-axis direction, and the single topmost microfluidic device 100H can be taken out. Therefore, one microfluidic device can be taken out from a plurality of fixedly stacked microfluidic devices while protecting the principal surface of the microfluidic device.

Further, when the microfluidic devices 100H are stacked on top of each other, a gap is formed between adjacent microfluidic devices 100H. By doing so, it becomes possible for a sensor to recognize the boundary between overlapping microfluidic devices, enabling automatic transport of individual microfluidic devices and automatic measurement of the number of stacked microfluidic devices.

In the microfluidic device 100I of Example 3, on a surface 20IT in the positive Z-axis direction of the plate-shaped member 20I, ribs 30 extending in the Y-axis direction are disposed along the sides at both ends in the X-axis direction. That is, when the substrate of the plate-shaped member 20I is substantially rectangular, the rib 30 includes at least two ribs: a rib disposed in contact with a side in the X-axis direction on the positive Y-axis direction side of one surface of the substrate of the plate-shaped member 20I, and a rib disposed in contact with another side of one surface of the substrate of the plate-shaped member 20I. As shown in the upper diagram, when viewed in plan from the positive Z-axis direction, the rib 30 is a quadrangle. Note that the rib 30 may be a triangle, a quadrangle, a rectangle with arc-shaped corners, or any other shape.

As shown in the middle diagram, the rib 30 protrudes in the positive Z-axis direction and extends flatly in the Y-axis direction. Also, as shown in the middle and lower diagrams, on a surface 20IB in the negative Z-axis direction of the plate-shaped member 20I, a recessed portion 40 is formed at a position corresponding to the rib 30. The length of the rib 30 in the X-axis direction is shorter than the length of the recessed portion 40 in the X-axis direction. That is, when viewed in plan from the Z-axis direction, the rib 30 overlaps with the recessed portion 40. By doing so, when the plate-shaped members 20I are stacked in the Z-axis direction, the rib 30 fits into the recessed portion 40.

As shown in the lower diagram, the recessed portion 40 is formed on the surface 20IB of the plate-shaped member, in a direction parallel to the sides at both ends in the X-axis direction of the plate-shaped member 20I. The recessed portion 40 is formed so as to penetrate to one side or the other side along the X-axis direction of the plate-shaped member 20I. Note that the plurality of recessed portions 40 need to be formed on both sides.

By forming the ribs and the recessed portions in this way, the microfluidic devices 100I can be fixedly stacked in the Z-axis direction, and the single topmost microfluidic device 100I can be taken out. Therefore, one microfluidic device can be taken out from a plurality of fixedly stacked microfluidic devices while protecting the principal surface of the microfluidic device.

Further, when the microfluidic devices 100I are stacked on top of each other, a gap is formed between adjacent microfluidic devices 100I. By doing so, it becomes possible for a sensor to recognize the boundary between overlapping microfluidic devices, enabling automatic transport of individual microfluidic devices and automatic measurement of the number of stacked microfluidic devices.

### Modification 6

In FIG. 7 and FIG. 8, the structure of the ribs and the recessed portions when the microfluidic devices are stacked has been described. In Modification 6, the structure of the ribs and the recessed portions when the microfluidic device is placed in other equipment will be described.

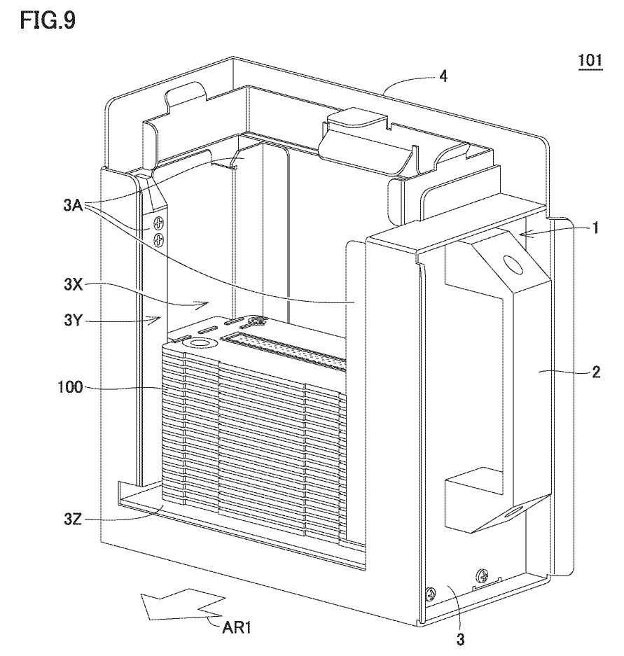

FIG. 9 is a diagram for explaining a detailed structure of the storage unit 101, which is an example of other equipment. Referring to FIG. 9, the storage unit 101 includes a frame 4 and a container 1. The container 1 is mounted in the frame 4. The container 1 is detachable from the frame 4. The container 1 includes a handle 2 and a main body 3. The user holds the handle 2 to mount the container 1 in the frame 4 and to remove the container 1 from the frame 4.

As shown in FIG. 9, a space 3X represents the space inside the main body 3 of the container 1. A guide 3A is disposed at each of the corners inside the main body 3. An opening 3Y is provided on the front surface of the main body 3. FIG. 9 shows a state in which the microfluidic device 100 is stored inside the main body 3. A bottom surface 3Z indicates the bottom surface of the main body 3 of the container 1.

New microfluidic devices 100 before use are placed on the bottom surface 3Z or on a microfluidic device already stacked on the bottom surface 3Z. When taking out the microfluidic devices 100 stored in the storage unit 101, they are pulled out in the direction of arrow AR1 in order from the lowermost microfluidic device 100 of the stacked microfluidic devices 100. The transport unit 500 pulls out, in the direction of arrow AR1, the microfluidic device 100 that is in contact with the bottom surface 3Z from among the plurality of microfluidic devices 100 stacked inside the main body 3, via the opening 3Y.

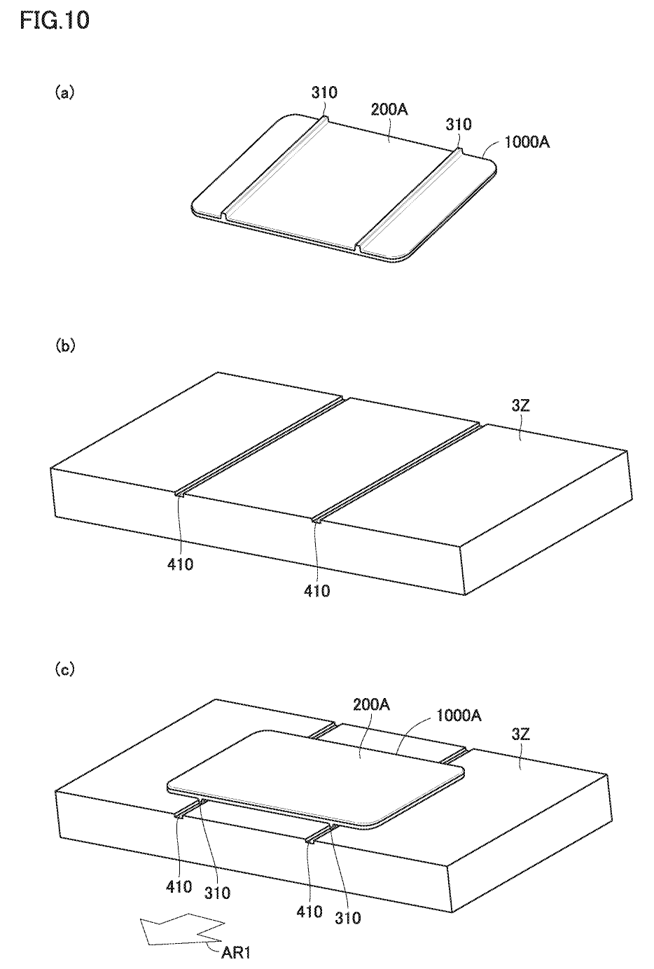

FIG. 10 is a diagram for explaining the structure of the bottom surface 3Z of the storage unit 101 in FIG. 9. In FIG. 10, (a) shows a microfluidic device 1000A, (b) shows the bottom surface 3Z of the storage unit 101, and (c) shows a state in which a rib 310 of the microfluidic device 1000A fits into a recessed portion 410 of the storage unit 101.

On a plate-shaped member 200A of the microfluidic device 1000A, ribs 310 are disposed extending in the short-side direction of the plate-shaped member, similar to Example 1 in FIG. 7 (upper part (a)). At this time, on the bottom surface 3Z of the container 1 of the storage unit 101, recessed portions 410 corresponding to the ribs 310 are formed (middle part (b)). With such a configuration, as shown in the lower part (c), the ribs 310 of the plate-shaped member 200A of the microfluidic device 1000A fit into the recessed portions 410 of the bottom surface 3Z of the container 1 of the storage unit 101.

Further, the recessed portion 410 penetrates in the direction of the opening 3Y in FIG. 9. This allows the microfluidic device placed at the lowest level to be pulled out in the direction of arrow AR1.

Therefore, one microfluidic device can be pulled out from a plurality of stacked microfluidic devices while protecting the principal surface of the microfluidic device.

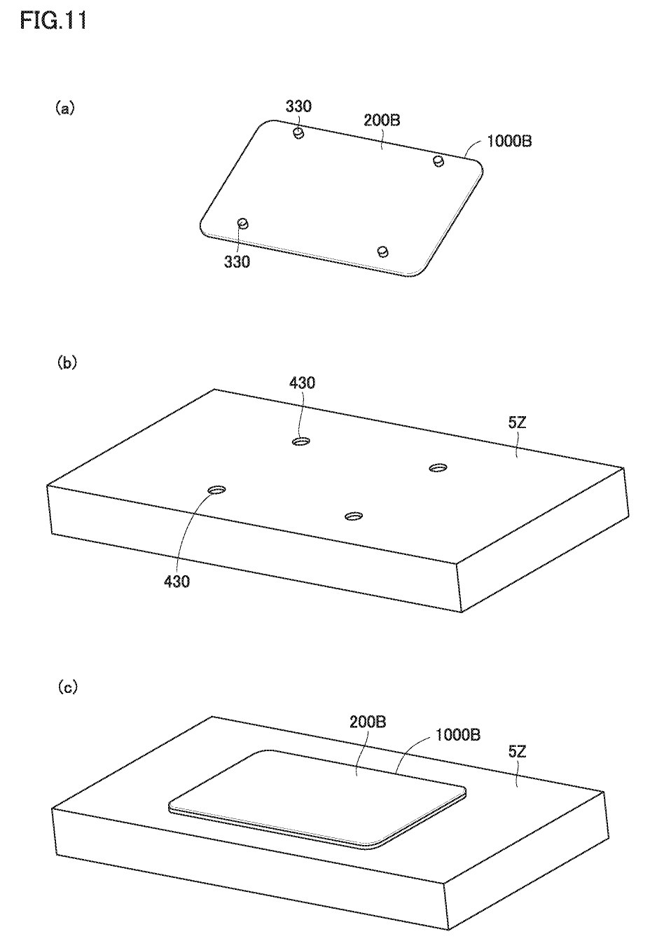

FIG. 11 is a diagram for explaining the structure of a bottom surface 5Z of the storage unit 101 in FIG. 9. In FIG. 11, (a) shows a microfluidic device 1000B, (b) shows the bottom surface 5Z of the storage unit 101, and (c) shows a state in which a rib 330 of the microfluidic device 1000B fits into a recessed portion 430 of the storage unit 101.

On a plate-shaped member 200B of the microfluidic device 1000B, ribs 330 existing at the four corners of the plate-shaped member are disposed, similar to Example 3 in FIG. 8 (upper part (a)). At this time, on the bottom surface 5Z of the storage unit 101, recessed portions 430 corresponding to the ribs 330 are formed (middle part (b)). With such a configuration, as shown in the lower part (c), the ribs 330 of the plate-shaped member 200B of the microfluidic device 1000B fit into the recessed portions 430 of the bottom surface 5Z of the storage unit 101.

Therefore, one microfluidic device can be taken out from a plurality of fixedly stacked microfluidic devices while protecting the principal surface of the microfluidic device from the principal surface of another microfluidic device.

In this way, when the microfluidic device is placed in other equipment, depending on the structure of the ribs of the microfluidic device and the recessed portions of the other equipment, one microfluidic device can be taken out from a plurality of stacked microfluidic devices while protecting the principal surface of the microfluidic device from the principal surface of another microfluidic device.

### Aspects

It will be understood by those skilled in the art that the plurality of exemplary embodiments described above are specific examples of the following aspects.

(Item 1) A microfluidic device according to one aspect includes a plate-shaped member, a projection disposed on the plate-shaped member, and a first projecting portion disposed on the plate-shaped member. The plate-shaped member has a substrate having a first surface and a second surface, and a plurality of microfluidic channels formed on one of the surfaces. The projection and the first projecting portion are disposed on the first surface of the substrate. A distance from the first surface to a farthest end of the first projecting portion is greater than a distance from the first surface to a farthest end of the projection.

According to the microfluidic device of Item 1, a rib is disposed on the plate-shaped member of the microfluidic device. This makes it possible to prevent the principal surface of the microfluidic device from contacting another microfluidic device when the microfluidic devices are stored stacked, and thus the principal surface of the microfluidic device can be protected.

(Item 2) In the microfluidic device according to Item 1, a first recessed portion is formed on the second surface of the substrate. When the plate-shaped member is viewed in plan from a normal direction of the first surface, the first projecting portion overlaps with the first recessed portion.

According to the microfluidic device of Item 2, the recessed portion is formed so as to include the rib when the microfluidic device is viewed in plan. This allows the rib to fit into the recessed portion of another microfluidic device when the microfluidic devices are stacked, so that the microfluidic device can be fixed or pulled out depending on the shape of the rib and the recessed portion, while protecting the principal surface of the microfluidic device.

(Item 3) In the microfluidic device according to Item 2, the first recessed portion is formed at a position other than an end of the substrate.

According to the microfluidic device of Item 3, the recessed portion is formed so as not to contact the end of the substrate, and the rib is formed so as to fit into the recessed portion. This makes it possible to fix the microfluidic device while protecting its principal surface.

(Item 4) The microfluidic device according to Item 2 further includes a second projecting portion disposed on the first surface of the substrate. A second recessed portion is formed on the second surface of the substrate. The substrate is substantially rectangular. The first projecting portion is disposed in contact with a first side of the first surface of the substrate. The second projecting portion is disposed in contact with a second side, a third side, or a fourth side at a position different from the first projecting portion on the first surface of the substrate. The second projecting portion overlaps with the second recessed portion when the plate-shaped member is viewed in plan.

According to the microfluidic device of Item 4, two sets of ribs and recessed portions are formed so as to be in contact with the sides of the rectangular substrate, and the sides that each set contacts are different. This prevents the microfluidic device from being pulled out, making it possible to fix the microfluidic device while protecting its principal surface.

(Item 5) In the microfluidic device according to Item 2, the first recessed portion is formed along a periphery of the second surface of the substrate. The first projecting portion is disposed along a periphery of the first surface of the substrate.

According to the microfluidic device of Item 5, the recessed portion is formed along the periphery of one surface of the substrate, and the rib is formed along the periphery of the other surface of the substrate. This makes it possible to fix the microfluidic device while protecting its principal surface.

(Item 6) In the microfluidic device according to Item 2, the first recessed portion is formed to extend linearly to an end of the substrate.

According to the microfluidic device of Item 6, the recessed portion is formed so as to be in contact with the side of the surface of the substrate. This makes it possible to pull out the microfluidic device while protecting its principal surface.

(Item 7) In the microfluidic device according to Item 6, the projecting portion extends in a first direction, and an inclination is formed at an end of the projecting portion in the first direction.

According to the microfluidic device of Item 7, the end of the rib of the substrate is inclined. This makes it possible to protect the principal surface of the microfluidic device from the corner of the rib of an upper or lower microfluidic device when pulling out one microfluidic device from a plurality of stacked microfluidic devices.

(Item 8) The microfluidic device according to any one of Items 1 to 7 further includes a functional component provided on the substrate. In a normal direction of the plate-shaped member, a distance from the first surface to a farthest end of the first projecting portion is greater than a distance from a surface on which the functional component is provided to a farthest end of the functional component.

According to the microfluidic device of Item 8, the height of the rib is greater than the height of the functional component. This ensures that when the microfluidic device is stacked on a table or a similarly structured microfluidic device, the rib, not the functional component, contacts the table or the similarly structured microfluidic device. Therefore, the observed region of the principal surface of the microfluidic device and the functional component such as a sensor do not contact the table or the similarly structured microfluidic device, and the principal surface of the microfluidic device can be protected.

(Item 9) The microfluidic device according to any one of Items 2 to 7 further includes a functional component provided on the substrate. In a normal direction of the plate-shaped member, a value obtained by subtracting a distance from the second surface to a bottom of the first recessed portion from a distance from the first surface to a farthest end of the first projecting portion is greater than a distance from a surface on which the functional component is provided to a farthest end of the functional component.

According to the microfluidic device of Item 9, the value obtained by subtracting the depth of the recessed portion from the height of the rib is greater than the height of the functional component. This ensures that when similarly structured microfluidic devices are stacked, the rib, not the functional component, contacts the upper or lower microfluidic device. Therefore, the observed region of the principal surface of the microfluidic device and the functional component such as a sensor do not contact the similarly structured microfluidic device, and the principal surface of the microfluidic device can be protected.

(Item 10) The microfluidic device according to any one of Items 1 to 9 further includes a third projecting portion disposed on the second surface of the substrate.

According to the microfluidic device of Item 10, ribs are disposed on both one surface and the other surface of the substrate. This ensures that when the microfluidic device is stacked on a table or a similarly structured microfluidic device, the rib contacts the table or the similarly structured microfluidic device. Therefore, the principal surface and the other surface of the microfluidic device do not contact the table or the similarly structured microfluidic device, and the principal surface and the other surface of the microfluidic device can be protected.

(Item 11) In the microfluidic device according to Item 10, a third recessed portion is formed on the first surface of the substrate, and the third projecting portion overlaps with the third recessed portion when the plate-shaped member is viewed in plan.

According to the microfluidic device of Item 11, ribs are disposed on both one surface and the other surface of the substrate, and a recessed portion corresponding to the rib on the other surface is formed on the one surface. This ensures that when the microfluidic device is stacked on a table or a similarly structured microfluidic device, the rib contacts the table or the similarly structured microfluidic device. Therefore, the principal surface and the other surface of the microfluidic device do not contact the table or the similarly structured microfluidic device, and the principal surface and the other surface of the microfluidic device can be protected.

(Item 12) In the plate-shaped member of the microfluidic device according to any one of Items 1 to 11, the plate-shaped member further includes a film that covers the plurality of microfluidic channels on the surface of the substrate on which the plurality of microfluidic channels are formed. A distance from the first surface to a farthest end of the first projecting portion is greater than a distance from the surface of the substrate on which the plurality of microfluidic channels are formed to a farthest end of the film.

According to the microfluidic device of Item 12, the height of the rib is greater than the thickness of the film covering the microfluidic channels. This ensures that when similarly structured microfluidic devices are stacked, the rib, not the film, contacts the upper or lower microfluidic device. Therefore, the principal surface of the microfluidic device does not contact the similarly structured microfluidic device, and the principal surface of the microfluidic device can be protected.

(Item 13) In the microfluidic device according to Item 8 or 9, the functional component includes an RFID (Radio Frequency Identification) in which identification information is stored. The identification information is used for measuring the number of microfluidic devices.

(Item 14) In the microfluidic device according to any one of Items 1 to 13, the projection is an opening for injecting a reagent into the microfluidic device.

The embodiments disclosed this time should be considered illustrative in all respects and not restrictive. The scope of the present invention is indicated by the claims rather than by the description of the embodiments described above, and all modifications within the meaning and scope equivalent to the claims are intended to be included.

### Reference Signs List

1 Container,

2 Handle,

3 Main body,

3A Guide,

3X Space,

3Y, 22, 26, 29 Opening,

3Z Bottom surface,

4 Frame,

5Z Bottom surface,

18 Substrate,

19 Film,

50 Incubator,

20, 20A, 20B, 20C, 20D, 20E, 20F, 20G, 20H, 20I, 200A, 200B Plate-shaped member,

23 Main channel,

24 Microfluidic channel,

25 Reservoir,

27 Gas permeable membrane,

28 Recovery unit,

30, 31, 32, 33, 34, 35, 36, 37, 38, 39, 310, 330 Rib,

40, 41, 42, 43, 44, 45, 46, 47, 48, 49, 430 Recessed portion,

82 Sensor,

84 Projection,

100, 100A, 100B, 100C, 1000A, 1000B Microfluidic device,

101 Storage unit,

103 Injection unit,

120 Control unit,

122 Processor,

140 Microscope camera,

142 Objective lens,

144 Focus changing mechanism,

146 Image sensor,

160 Stage,

162 Imaging field-of-view changing mechanism,

162X X-axis moving mechanism,

162Y Y-axis moving mechanism,

164 Illumination device,

180 Reading unit,

190 Disposal unit,

200 Testing apparatus,

500 Transport unit.

1. A microfluidic device, comprising:
a plate-shaped member;
a projection disposed on the plate-shaped member; and
a first projecting portion disposed on the plate-shaped member,
wherein the plate-shaped member
has a substrate having a first surface and a second surface, and a plurality of microfluidic channels formed on one of the surfaces,
the projection and the first projecting portion are disposed on the first surface of the substrate, and
a distance from the first surface to a farthest end of the first projecting portion is greater than a distance from the first surface to a farthest end of the projection.

2. The microfluidic device according to claim 1, wherein
a first recessed portion is formed on the second surface of the substrate, and
when the plate-shaped member is viewed in plan from a normal direction of the first surface, the first projecting portion overlaps with the first recessed portion.

3. The microfluidic device according to claim 2, wherein the first recessed portion is formed at a position other than an end of the substrate.

4. The microfluidic device according to claim 2, further comprising a second projecting portion disposed on the first surface of the substrate,
wherein a second recessed portion is formed on the second surface of the substrate,
the substrate is substantially rectangular,
the first projecting portion is
disposed in contact with a first side of the first surface of the substrate,
the second projecting portion is
disposed in contact with a second side, a third side, or a fourth side at a position different from the first projecting portion on the first surface of the substrate, and
overlaps with the second recessed portion when the plate-shaped member is viewed in plan.

5. The microfluidic device according to claim 2, wherein
the first recessed portion is formed along a periphery of the second surface of the substrate, and
the first projecting portion is disposed along a periphery of the first surface of the substrate.

6. The microfluidic device according to claim 2, wherein the first recessed portion is formed to extend linearly to an end of the substrate.

7. The microfluidic device according to claim 6, wherein
the first projecting portion extends in a first direction, and
an inclination is formed at an end of the first projecting portion in the first direction.

8. The microfluidic device according to claim 1, further comprising a functional component provided on the substrate,
wherein, in a normal direction of the plate-shaped member, a distance from the first surface to a farthest end of the first projecting portion is greater than a distance from a surface on which the functional component is provided to a farthest end of the functional component.

9. The microfluidic device according to claim 2, further comprising a functional component provided on the substrate,
wherein, in a normal direction of the plate-shaped member, a value obtained by subtracting a distance from the second surface to a bottom of the first recessed portion from a distance from the first surface to a farthest end of the first projecting portion is greater than a distance from a surface on which the functional component is provided to a farthest end of the functional component.

10. The microfluidic device according to claim 1, further comprising a third projecting portion disposed on the second surface of the substrate.

11. The microfluidic device according to claim 10, wherein
a third recessed portion is formed on the first surface of the substrate, and
the third projecting portion overlaps with the third recessed portion when the plate-shaped member is viewed in plan.

12. The microfluidic device according to claim 11, wherein
the plate-shaped member further includes a film that covers the plurality of microfluidic channels on the surface of the substrate on which the plurality of microfluidic channels are formed, and
a distance from the first surface to a farthest end of the first projecting portion is greater than a distance from the surface of the substrate on which the plurality of microfluidic channels are formed to a farthest end of the film.

13. The microfluidic device according to claim 8, wherein
the functional component includes an RFID (Radio Frequency Identification) in which identification information is stored, and
the identification information is used for measuring the number of the microfluidic devices.

14. The microfluidic device according to claim 1, wherein the projection is an opening for injecting a reagent into the microfluidic device.
